(19) United States
(12) Patent Application Publication
(10) Pub. No.: US 2018/0258947 A1
(43) Pub. Date: Sep. 13, 2018

(54) AXIAL FAN

(71) Applicant: Nidec Corporation, Kyoto (JP)

(72) Inventors: Mikiya HIROSE, Kyoto (JP); Takamasa OSHITA, Kyoto (JP)

(21) Appl. No.: 15/911,453

(22) Filed: Mar. 5, 2018

Related U.S. Application Data
(60) Provisional application No. 62/469,597, filed on Mar. 10, 2017.

(30) Foreign Application Priority Data
Feb. 23, 2018 (JP) 2018-030290

(51) Int. Cl. F04D 29/38; F04D 29/32; F04D 29/54; F04D 29/52; F04D 29/58; F04D 29/68

(52) U.S. Cl. CPC F04D 29/386; F04D 29/325; F04D 29/544; F04D 29/526; F05D 2250/712; F04D 29/681; F05D 2240/307; F05D 2250/32; F04D 29/582

(57) ABSTRACT

An axial fan includes an impeller that is provided with a blade that rotates around a central axis extending in a vertical direction, a motor unit that rotates the impeller, and a housing that is provided closer to a radially outer side than the impeller and surrounds the impeller. The impeller is further provided with an assist blade that protrudes at least in an axial direction from a radially outer end portion of the blade and extends in a circumferential direction. The assist blade is provided with a variable width portion at which an assist blade width between the blade and a tip end portion of the assist blade in a direction in which the assist blade protrudes decreases toward a rear side in a rotation direction from a front side in the rotation direction.

### CROSS REFERENCE TO RELATED APPLICATIONS

This application claims the benefit of priority to U.S. Patent Application No. 62/469,597 filed on Mar. 10, 2017 and Japanese Patent Application No. 2018-030290 filed on Feb. 23, 2018. The entire contents of these applications are hereby incorporated herein by reference.

### BACKGROUND OF THE INVENTION

### 1. Field of the Invention

The present disclosure relates to an axial fan.

### 2. Description of the Related Art

In the related art, a cooling fan for cooling an electronic component is provided in a casing of various electronic machines and there is a demand for improvement in static pressure-air volume characteristic of the cooling fan because of an increase in amount of heat generation which is caused by improvement in performance of the electronic component and an increase in arrangement density which is caused by reduction in size of the casing. In recent years, an axial fan, in which an auxiliary blade such as an assist blade is attached to an outer circumferential portion of a blade, has been proposed as a cooling fan for securing a sufficient static pressure and a sufficient air volume.

For example, in the case of an axial fan disclosed in Japanese Laid-open Patent Application Publication 2016-17457, air that flows toward an outer circumferential edge portion of a blade main body along a positive pressure surface of the blade main body collides with a rib formed on the outer circumferential edge portion and is guided to a leeward side along the rib. Therefore, the air that flows toward the outer circumferential edge portion of the blade main body along the positive pressure surface of the blade main body is restrained from proceeding toward a negative pressure surface side over an outer circumferential edge of the blade main body.

In addition, in the case of an axial fan disclosed in Japanese Laid-open Patent Application Publication 2005-105865, an auxiliary blade is attached to a negative pressure surface side of an outer circumferential portion of a blade for the purpose of reducing noise that is generated when the blade rotates at a high speed.

Meanwhile, a rear portion of an edge of a blade in a rotation direction is preferably thin in order that an air stream on a positive pressure surface of the blade and an air stream on a negative pressure surface join each other without turbulence. However, on a negative pressure surface side of a rear end portion of the edge in the rotation direction, an air stream that proceeds to a radially outer side after flowing toward a negative pressure surface side of the blade is generated. The air stream forcefully presses an assist blade to the radially outer side at the rear portion of the edge in the rotation direction such that a large load is applied to the assist blade provided on the edge and the blade to which the auxiliary blade is attached. With regard to the above-described problem, Japanese Laid-open Patent Application Publication 2016-17457 discloses a technique in which the rib is provided on the outer circumferential edge portion of the blade main body such that static pressure and air volume performance are improved. In addition, Japanese Laid-open Patent Application Publication 2005-105865 discloses a technique in which the auxiliary blade is attached to the negative pressure surface side of the outer circumferential portion of the blade such that noise is reduced.

### SUMMARY OF THE INVENTION

An exemplary axial fan according to the disclosure includes an impeller that is provided with a blade that rotates around a central axis extending in a vertical direction, a motor unit that rotates the impeller, and a housing that is provided closer to a radially outer side than the impeller and surrounds the impeller. The impeller is further provided with an assist blade that protrudes at least in an axial direction from a radially outer end portion of the blade and extends in a circumferential direction. The assist blade is provided with a variable width portion at which an assist blade width between the blade and a tip end portion of the assist blade in a direction in which the assist blade protrudes decreases toward a rear side in a rotation direction from a front side in the rotation direction.

With an exemplary axial fan according to the present disclosure, it is possible to reduce a load applied to a blade provided with an assist blade.

The above and other elements, features, steps, characteristics and advantages of the present discloser will become more apparent from the following detailed description of the preferred embodiments with reference to the attached drawings.

### BRIEF DESCRIPTION OF THE DRAWINGS

FIG. 1 is a sectional view illustrating an example of an axial fan.

FIG. 2 is a top view illustrating an example of the axial fan.

FIG. 3 is a perspective view illustrating an example of an impeller.

FIG. 4 is a top view illustrating another example of the axial fan.

FIG. 5 is an enlarged view illustrating an example of a sectional structure of the vicinity of an assist blade at a maximum width portion.

FIG. 6 is an enlarged view illustrating an example of another sectional structure in the vicinity of the assist blade at the maximum width portion.

### DETAILED DESCRIPTION OF THE PREFERRED EMBODIMENTS

Hereinafter, an exemplary embodiment of the disclosure will be described with reference to drawings.

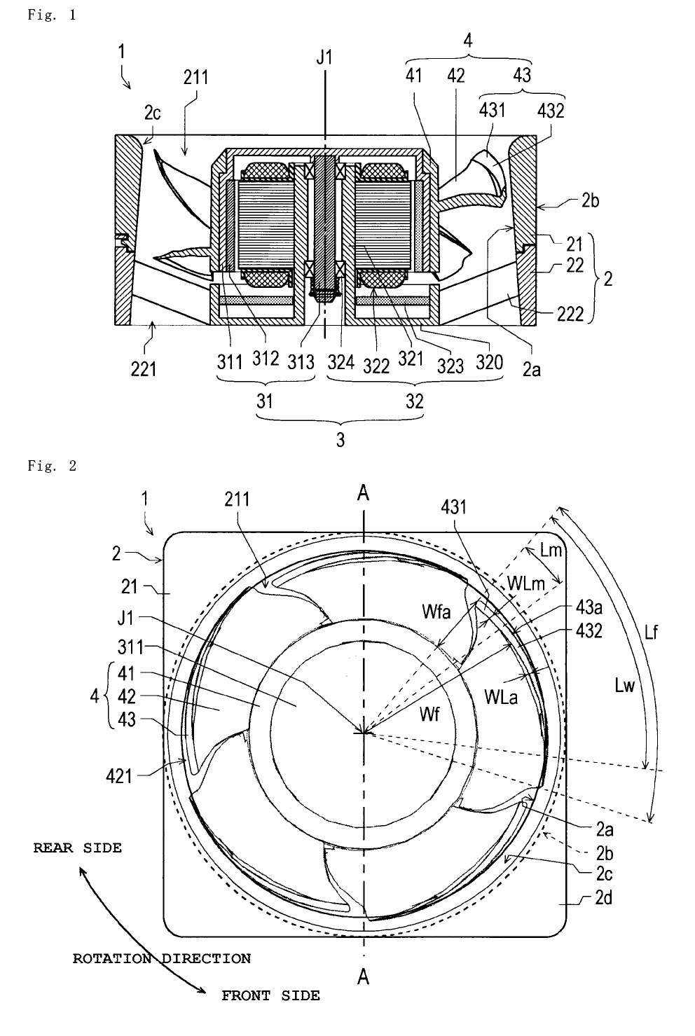

Note that, in the present specification, a direction parallel to a central axis J1 of an axial fan 1 will be referred to as an “axial direction”. The upper side in FIG. 1 is an intake side of the axial fan 1 and the lower side in FIG. 1 is an exhaust side of the axial fan 1. Regarding the axial direction, a direction from the lower side to the upper side in FIG. 1 will be referred to as an “axially upper side”, which is one side in the axial direction, and a direction from the upper side to the lower side in FIG. 1 will be referred to as an “axially lower side”, which is the other side in the axial direction. In other words, the “the axially upper side” is a direction from an exhaust port 221 which will be described later to an intake port 211 which will be described later, the direction being a direction along the axial direction. The “the axially lower side” is a direction from the intake port 211 to the exhaust port 221, the direction being a direction along the axial direction. Note that, the axial direction does not need to coincide with a vertical direction. The “axially upper side” does not need to coincide with a vertically upper side and the “the axially lower side” does not need to coincide with a vertically lower side. With regard to each constituent component, an end portion on the axially upper side will be referred to as an “axially upper end portion” and the position of an end on the axially upper side will be referred to as an “axially upper end”. In addition, an end portion on the axially lower side will be referred to as an “axially lower end portion” and the position of an end on the axially lower side will be referred to as an “axially lower end”. In addition, with regard to surfaces of each constituent component, a surface facing the axially upper side will be referred to as an “upper surface” and a surface facing the axially lower side will be referred to as a “lower surface”.

A direction orthogonal to the central axis J1 will be referred to as a “radial direction”. Regarding the radial direction, a direction toward the central axis J1 will be referred to as a “radially inner side” and a direction away from the central axis J1 will be referred to as a “radially outer side”. With regard to each constituent component, an end portion on the radially inner side will be referred to as a “radially inner end portion” and the position of an end on the radially inner side will be referred to as a “radially inner end”. With regard to each constituent component, an end portion on the radially outer side will be referred to as a “radially outer end portion” and the position of an end on the radially outer side will be referred to as a “radially outer end”. In addition, with regard to side surfaces of each constituent component, a side surface facing the radially inner side will be referred to as a “radially inner surface” and a side surface facing the radially outer side will be referred to as a “radially outer surface”.

A rotation direction of an impeller 4 (which will be described later) around the central axis J1 may be referred to as a “circumferential direction” in some cases. In addition, a side, to which blades 42 (which will be described) of the rotating impeller 4 advance along the circumferential direction, will be referred to as a “front side in the rotation direction” and a side, to which the blades 42 of the rotating impeller 4 retreat along the circumferential direction, will be referred to as a “rear side in the rotation direction”. In other words, the “rear side in the rotation direction” is opposite to the “front side in the rotation direction” in the circumferential direction. With regard to each constituent component, an end portion on the front side in the rotation direction will be referred to as a “front side end portion in the rotation direction” and the position of an end on the front side in the rotation direction will be referred to as a “front end in the rotation direction”. In addition, with regard to each constituent component, an end portion on the rear side in the rotation direction will be referred to as a “rear side end portion in the rotation direction” and the position of an end on the rear side in the rotation direction will be referred to as a “rear end in the rotation direction”.

Note that, the above-described names of the directions, the end portions, the positions of the ends, and the surfaces do not represent a positional relationship and directions pertaining to a case where the axial fan is assembled with an actual machine.

FIG. 1 is a sectional view illustrating an example of the axial fan 1. FIG. 2 is a top view illustrating an example of the axial fan 1. Note that, FIG. 1 illustrates a section of the axial fan 1 that is taken along a two-dot chain line A-A in FIG. 2 and illustrates a sectional configuration of the axial fan 1 pertaining to a case where the axial fan 1 is virtually cut with a plane including the central axis J1. In addition, in FIG. 2, for the purpose of facilitating the understanding of the configuration, a housing 2 is illustrated in a see-through manner.

The axial fan 1 is provided with the housing 2, a motor unit 3, and the impeller 4. The impeller 4 includes the blades 42 that can rotate around the central axis J1 extending in the vertical direction. The motor unit 3 rotates the impeller 4 around the central axis J1. The housing 2 is provided closer to the radially outer side than the impeller 4 and surrounds the impeller 4.

In the axial fan 1, an air stream that flows from the axially upper side to the axially lower side is generated when the impeller 4 is rotated. More specifically, air is taken into the axial fan 1 via a first opening portion provided in an axially upper end portion of the housing 2 when the impeller 4 is rotated. The air taken in forms an air stream sent to the axially lower side and the air is discharged via a second opening portion provided in an axially lower end portion of the housing 2. That is, the first opening portion of the housing 2 is the intake port 211 and is provided closer to the axially upper side than the impeller 4. The second opening portion of the housing 2 is the exhaust port 221 and is provided closer to the axially lower side than the impeller 4.

The housing 2 has a tubular shape and accommodates the motor unit 3 and the impeller 4. The inside of the housing 2 is a wind tunnel in which an air stream toward the axially lower side is generated when the impeller 4 is rotated. The housing 2 is provided with a housing inner surface 2a, a housing outer surface 2b, the intake port 211 provided in the axially upper end portion, and the exhaust port 221 provided in the axially lower end portion. Note that, the housing inner surface 2a is a radially inner surface of the housing 2 and the housing outer surface 2b is a radially outer surface of the housing 2. In addition, the positions of the intake port 211 and the exhaust port 221 in the axial direction are not defined strictly but in the present embodiment, the position of the intake port 211 in the axial direction is a position at which the radial width between the housing inner surface 2a and the central axis J1 becomes minimum. The position of the exhaust port 221 in the axial direction is an axially lower end of the housing inner surface 2a.

Except for the axially upper end portion, the radial width between the housing inner surface 2a and the central axis J1 increases toward the exhaust port 221 from the intake port 211. In other words, except for the axially upper end portion of the housing 2, the housing inner surface 2a of the housing 2 becomes farther from the central axis J1 toward the axially lower side and becomes closer to the radially outer side toward the axially lower side. More specifically, at a position closer to the axially lower side than the intake port 211, the wind tunnel inside the housing inner surface 2a has a truncated conical shape that gradually expands toward the radially outer side as it goes toward the axially lower side. Therefore, an air stream proceeding toward the radially outer side is easily sent to the axially lower side and thus it is possible to suppress the generation of noise and to improve static pressure and air volume performance. Meanwhile, in a case where the wind tunnel inside the housing inner surface 2a has a cylindrical shape, since a portion of the air stream proceeding toward the radially outer side proceeds toward the axially upper side, the static pressure and air volume performance of the axial fan 1 are deteriorated and noise is likely to be generated in comparison with a configuration in the embodiment in which the wind tunnel has the truncated conical shape that expands on the axially lower side.

Except for the axially upper end portion and the axially lower end portion of the housing 2, the housing outer surface 2b is parallel to the central axis J1. Therefore, except for the axially upper end portion and the axially lower end portion of the housing 2, the thickness of the housing 2 in the radial direction decreases toward the axially lower side. More specifically, the thickness of the housing 2 in the radial direction in an area from the intake port 211 to ribs 222 can be larger than the thickness of the housing 2 in the radial direction in an area from the ribs 222 to the exhaust port 221. Therefore, it is possible to secure the hardness of the housing 2 that corresponds to the weight, vibration, or the like of the motor unit 3. Meanwhile, since the thickness of the housing 2 in the radial direction decreases toward the exhaust port 221, the caliber of the wind tunnel, through which an air stream flows, as seen in the axial direction can increase toward the exhaust port 221. Therefore, it is possible to secure a wind tunnel that is larger than that in a case where the caliber of a wind tunnel between the intake port 211 and the exhaust port 221 is constant. Therefore, it is possible to secure the hardness of the housing 2 and to make the wind tunnel, through which an air stream flows, large. Note that, the disclosure is not limited to the above-described example and the housing outer surface 2b may not be parallel to the central axis J1.

The housing 2 is further provided with a bell mouth 2c and flanges 2d. The bell mouth 2c is provided in the axially upper end portion of the housing 2 and expands toward the radially outer side as it goes toward the axially upper side. More specifically, a portion of the housing inner surface 2a that is closer to the axially upper side than the intake port 211 is the bell mouth 2c in the axially upper end portion of the housing 2. A radial width between a radially inner surface of the bell mouth 2c and the central axis J1 increases toward the axially upper side. The radially inner surface of the bell mouth 2c is a curved surface that protrudes toward the axially upper side and the radially inner side. Since the bell mouth 2c that extends along the entire circumference of the intake port 211 is provided in the axially upper end portion of the housing 2, it is possible to suppress turbulence of an air stream that is taken into the intake port 211. Therefore, it is possible to improve the static pressure and air volume performance of the axial fan 1 and to reduce noise.

The flanges 2d are provided on the axially upper end portion and the axially lower end portion of the housing 2 and extend to the radially outer side from a radially outer end portion of the housing 2. The outer shape of each flange 2d is a quadrangular shape as seen in the axial direction.

In the present embodiment, the housing 2 is provided with an upper housing 21, a lower housing 22, and the plurality of ribs 222. An axially lower end portion of the upper housing 21 comes into contact with an axially upper end portion of the lower housing 22 and is attached to the axially upper end portion of the lower housing 22.

The upper housing 21 is provided with the intake port 211 and the flange 2d. More specifically, an inner surface of the upper housing 21 is provided with the intake port 211 and the flange 2d. The position of the intake port 211 in the axial direction is a position on the inner surface of the upper housing 21 at which the radial width between the central axis J1 and the inner surface becomes minimum. In addition, a portion of the inner surface of the upper housing 21 that is closer to the axially upper side than the intake port 211 is the bell mouth 2c.

The lower housing 22 is provided with the exhaust port 221. More specifically, the exhaust port 221 is provided in the lower housing 22. The position of the exhaust port 221 in the axial direction is an axially lower end of the lower housing 22.

The plurality of ribs 222 extend toward the radially inner side from a radially inner surface of the lower housing 22 and are connected to an axially lower end portion of the motor unit 3. More specifically, the plurality of ribs 222 are connected to a radially outer surface of a base portion 320, which will be described later, of the motor unit 3 and support the motor unit 3.

The upper housing 21, the lower housing 22, and the ribs 222 are molded through injection molding in which a resin material is used, for example. At this time, the lower housing 22 and the plurality of ribs 222 are molded into an integrated member having an integrated structure along with the base portion 320.

Next, the motor unit 3 will be described. The motor unit 3 is provided with a rotary portion 31 to which the impeller 4 is attached and a stationary portion 32 that rotatably supports the rotary portion 31.

The rotary portion 31 can rotate in the circumferential direction around the central axis J1, along with the impeller 4. The rotary portion 31 is provided with a rotor holder 311, a rotor magnet 312, and a shaft 313.

In the present embodiment, the rotor holder 311 is formed of metal and has a lidded tubular shape that extends in the axial direction while being centered on the central axis J1. In other words, the rotor holder 311 is provided with a plate-shaped lid portion that extends toward the radially outer side from the central axis J1 and a cylindrical portion that extends to the axially lower side from a radially outer end portion of the lid portion.

The rotor magnet 312 is provided with a plurality of magnetic poles which are different from each other and are alternately arranged in the circumferential direction. The rotor magnet 312 is fixed to a radially inner surface of the rotor holder 311. In the present embodiment, the rotor magnet 312 is a tubular member that extends in the axial direction. However, the disclosure is not limited to the above-described example and the rotor magnet 312 may be a plurality of magnet pieces arranged in the circumferential direction on the radially inner surface of the rotor holder 311.

The shaft 313 extends in the circumferential direction along the central axis J1 and can rotate around the central axis J1 along with the rotor holder 311 and the impeller 4. In the present embodiment, an axially upper end portion of the shaft 313 is fixed to the center of the lid portion of the rotor holder 311.

The stationary portion 32 is provided with the base portion 320, a bearing holder 321, a stator 322, a circuit board 323, and two bearings 324.

The base portion 320 is provided with a circular plate portion that is provided as the axially lower end portion of the motor unit 3 and expands in the radial direction and a tubular portion that extends toward the axially upper side from a radially outer end portion of the circular plate portion. The circular plate portion is disposed closer to the axially lower side than the circuit board 323. The tubular portion is disposed closer to the radially outer side than the circuit board 323 and surrounds the circuit board 323. The plurality of ribs 222 are connected to a radially outer surface of the tubular portion. The base portion 320 is held in the lower housing 22 by means of the plurality of the ribs 222.

The bearing holder 321 has a tubular shape that extends in the axial direction while being centered on the central axis J1 and extends toward the axially upper side from a radially inner end portion of the circular plate portion of the base portion 320. The bearings 324 are provided on the radially inner side of the bearing holder 321 and rotatably support the shaft 313.

The stator 322 drives and rotates the rotary portion 31. The stator 322 is an armature that is obtained by providing a coil portion on an annular stator core via an insulator, is disposed closer to the radially inner side than the rotor magnet 312, and faces the rotor magnet 312 with a radial gap provided therebetween. The stator 322 is attached to a radially outer surface of the bearing holder 321.

The circuit board 323 is disposed between the circular plate portion of the base portion 320 and the stator 322.

The two bearings 324 are provided on the radially inner surface of the bearing holder 321. The bearings 324 rotatably support the shaft 313. The bearings 324 may be ball bearings and may be slide bearings.

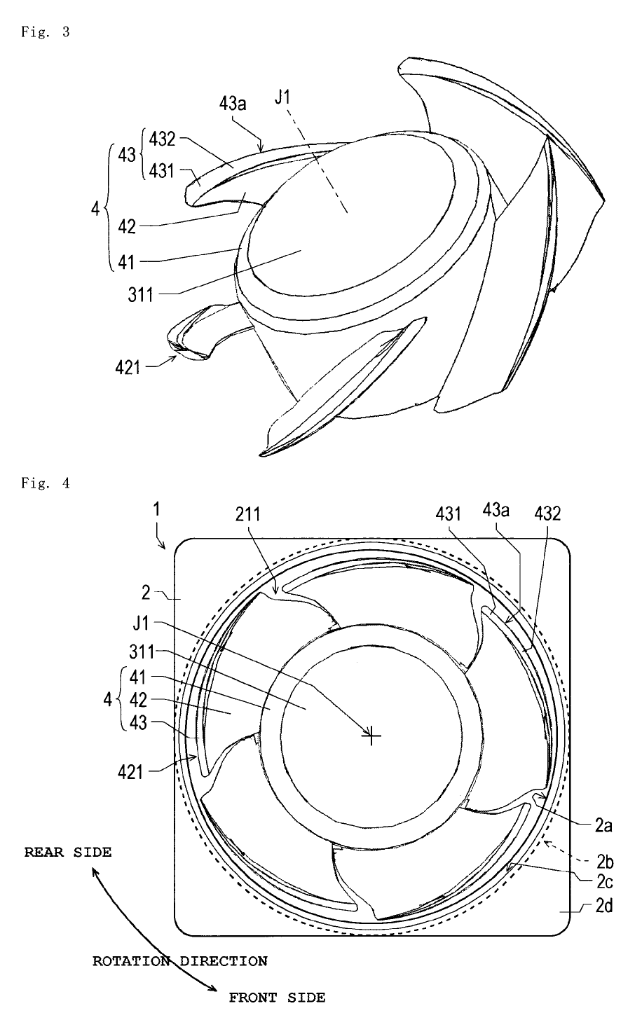

Next, the impeller 4 will be described with reference to FIGS. 2 and 3. FIG. 2 is a top view illustrating an example of the axial fan 1. FIG. 3 is a perspective view illustrating an example of the impeller 4. Note that, in FIG. 2, for the purpose of facilitating the understanding of the configuration, the housing 2 is illustrated in a see-through manner. As illustrated in FIGS. 2 and 3, the impeller 4 is provided with a tubular portion 41, the plurality of blades 42, and assist blades 43.

The tubular portion 41 is attached to the rotor holder 311 of the rotary portion 31. A radially inner end portion of each blade 42 is connected to the tubular portion 41. In the present embodiment, the tubular portion 41 has a tubular shape and comes into contact with a radially outer surface of the rotor holder 311. However, the disclosure is not limited to this example and the tubular portion 41 may come into contact with an upper surface of the lid portion of the rotor holder 311 as well. That is, the tubular portion 41 may have a lidded tubular shape. In addition, in the present embodiment, a radially outer surface of the tubular portion 41 is parallel to the axial direction. However, the disclosure is not limited to this example and the radially outer surface of the tubular portion 41 may be an inclined surface that becomes closer to the radially outer side toward the axially lower side. In other words, a radial width between the radially outer surface of the tubular portion 41 and the central axis J1 may slightly and gradually increase toward the axially lower side.

The plurality of blades 42 protrude toward the radially outer side from the radially outer surface of the tubular portion and are arranged at equal intervals in the circumferential direction. Each of the blades 42 extends in the circumferential direction and extends toward the axially lower side as it goes toward the rear side in the rotation direction from a front end portion in the rotation direction. In the axial fan 1, when the blades 42 rotate and press air, an air stream toward the axially lower side is generated but an air stream toward the radially outer side is also generated. Here, a pressure that is applied to each of upper surfaces of the blades 42 when the blades 42 rotate in the circumferential direction is smaller than a pressure that is applied to each of lower surfaces of the blades 42. Therefore, the lower surfaces of the blades 42 are positive pressure surfaces to which a positive pressure is applied and the upper surfaces of the blades 42 are negative pressure surfaces to which a negative pressure is applied. Therefore, a portion of the air stream toward the radially outer side flows toward the negative pressure surfaces from the positive pressure surfaces through radially outer end portions of the blades 42.

In the circumferential direction, a radial width Wf between radially outer end portions 421 of the blade 42 and the central axis J1 increases toward rear end portions in the rotation direction of the blades 42 from front end portions in the rotation direction of the blades 42. Air close to the positive pressure surfaces of the blades 42 is pressed toward a lower side in the axial direction by the blades 42 and is also pressed toward the radially outer side. Therefore, since the radial width Wf increases toward the rear side in the rotation direction, air that is pressed toward the radially outer side by the rotating blades 42 can be sent in the axial direction without being released to a position closer the radially outer side than the radially outer end portions 421. Therefore, the air blowing efficiency of the axial fan 1 is improved. Note that, hereinafter, the radially outer end portions 421 of the blades 42 will be referred to as “edges 421”.

In addition, in the axial direction, the radial width Wf increases toward axially lower end portions of the blades 42 from axially upper end portions of the blades 42.

It has been confirmed that a static pressure-air volume characteristic is improved even when the axial fan 1 has the same size if the axial fan 1 has a structure similar to that of a mixed flow fan as described above. However, the radial width Wf between the central axis J1 to the edges 421 does not need to gradually increase toward the exhaust port 221 from the intake port 211 in the strict sense. For example, a portion of each edge 421 may be slightly parallel to the central axis J1. In addition, other various shapes may be adopted as the shapes of the axially upper end portions and the axially lower end portions of the edges 421.

As seen in the axial direction, the position of a portion of each of the edges 421 of the blade 42 in the radial direction is preferably closer to the radially outer side than the intake port 211 as illustrated in FIG. 2. In other words, as seen in the axial direction, the minimum radial width between the housing inner surface 2a and the central axis J1 is preferably smaller than the maximum radial width between the edges 421 of the blades 42 and the central axis J1. According to this configuration, a gap between the housing inner surface 2a and the edges 421 of the blades 42 can be made narrower. Therefore, it is possible to suppress an air stream proceeding toward the upper surfaces, which are the negative pressure surfaces, over the lower surfaces of the rotating blades 42, which are the positive pressure surfaces. Accordingly, it is possible to further improve the static pressure in the axial fan 1 and to further improve the air blowing efficiency of the axial fan 1.

For example, in the present embodiment, a rear end portion in the rotation direction of each of the edges 421 of the blades 42 is positioned closer to the radially outer side than the intake port 211, which is the first opening portion of the housing 2. According to this configuration, a gap between the housing 2 and the blades 42 becomes uniform in the axial direction. Therefore, the internal pressure of the housing 2 is not likely to decrease and thus a high air blowing efficiency can be achieved.

Note that, the disclosure is not limited to an example illustrated in FIG. 2 and as seen in the axial direction, the positions of the edges 421 of the blades 42 in the radial direction may be closer to the radially inner side than the intake port 211. FIG. 4 is a top view of an axial fan according to a modification example. As illustrated in FIG. 4, as seen in the axial direction, the minimum radial width between the housing inner surface 2a and the central axis J1 may be larger than the maximum radial width between the edges 421 of the blades 42 and the central axis J1.

According to this configuration, when assembling the axial fan 1, it is possible to provide the impeller 4 by inserting the impeller 4 from the outside of the housing 2 such that the impeller 4 is positioned closer to the radially inner side than the housing inner surface 2a. Therefore, it is not needed to divide the housing 2 to upper and lower parts in the axial direction and thus it is possible to suppress an increase in the number of components of the axial fan 1. In addition, for example, a jig that is used when assembling the divided housing 2 is not needed unlike the above-described configuration illustrated in FIG. 2. Accordingly, it is possible to efficiently assemble the axial fan 1.

In addition, it is possible to provide a gap, which is needed in the assembly and is needed to prevent contact between the blades 42 and the housing 2 that is caused by an increase in radial dimensions of the blades 42 that is caused by vibration at the time of rotation, a centrifugal force, or a temporal change, between the housing inner surface 2a and the edges 421 of the blades 42. Therefore, it is possible to improve the static pressure in the axial fan 1 and to improve the air blowing efficiency.

Each of the edges 421 of the blades 42 is provided with the assist blade 43 that is warped and curved toward a negative pressure side. Each assist blade 43 is provided with a maximum width portion 431 and a variable width portion 432. As described above, the impeller 4 is provided with the assist blades 43. Each assist blade 43 protrudes at least in the axial direction from each of the edges 421 of the blades 42 and extends in the circumferential direction.

Preferably, the length Lw in the rotation direction of each assist blade 43 is equal to or greater than 60% of the length Lf in the rotation direction of each edge 421 and is equal to or smaller than 100% of the length Lf. In this case, the length Lw in the rotation direction of each assist blade 43 can be set to an appropriate dimension.

In the present embodiment, as illustrated in FIG. 2, the length Lw in the rotation direction of each assist blade 43=0.85*Lf is satisfied. That is, a rear end portion in the rotation direction of each assist blade 43 is positioned closer to the front side in the rotation direction than the rear end portion in the rotation direction of each of the edges 421 of the blade 42. According to this configuration, the rear end portion in the rotation direction of each of the edges 421 of the blades 42 is not provided with the assist blade 43. Therefore, the number of turbulent streams that are generated below lower surfaces of the rear end portions in the rotation direction of the blades 42, which are negative pressure surfaces, is smaller than that in a configuration in which the rear end portions in the rotation direction of the edges 421 of the blades 42 are provided with the assist blades 43. Therefore, the static pressure in the axial fan 1 becomes higher and the air blowing efficiency of the axial fan 1 is also improved. For example, with regard to the axial fan 1 according to the present embodiment, the highest static pressure and the highest air blowing efficiency are achieved in a case where Lw=0.85*Lf. In addition, a load in the radial direction that is applied to the rear end portions in the rotation direction of the blades 42 due to a centrifugal force at the time of rotation of the impeller 4 is further reduced in comparison with a configuration in which the rear end portions in the rotation direction of the blades 42 are provided with the assist blades 43. Furthermore, it is possible to suppress occurrence of deformation and a crack at the rear end portions in the rotation direction of the blades 42, which are thin.

Next, as described above, each assist blade 43 is provided with the maximum width portion 431. The maximum width portion 431 is a portion of each assist blade 43 at which an assist blade width WL becomes maximum and is provided closer to the front side in the rotation direction than the variable width portion 432. Note that, the assist blade width WL is the shortest distance between the blade 42 and a tip end portion 43a of the assist blade 43 in a direction in which the assist blade 43 protrudes.

Preferably, in FIG. 2, an assist blade width WLm at the maximum width portions 431 is equal to or greater than 5% of a radial width Wfa between the tip end portions 43a of the assist blades 43 and a radially outer end portion of the tubular portion 41 and is equal to or smaller than 20% of the radial width Wfa. In this case, the assist blade width WLm at the maximum width portions 431 can be set to an appropriate dimension. Therefore, it is possible to suppress the generation of an air stream that proceeds toward the upper surfaces, which are the negative pressure surfaces, over the lower surfaces of the blades 42, which are the positive pressure surfaces, at the maximum width portions 431. However, the disclosure is not limited to this example and 0.05*Wfa<WLm or 0.20*Wfa<WLm may also be satisfied.

In the present embodiment, each maximum width portion 431 is provided on the front end portion in the rotation direction of each of the edges 421 of the blades 42. Preferably, in FIG. 2, the length Lm in the rotation direction of each maximum width portion 431 is equal to or smaller than 20% of the length Lf in the rotation direction of each of the edges 421 of the blades 42. According to this configuration, it is possible to provide the assist blades 43 having an appropriate assist blade width WL at least on the front end portions in the rotation direction of the edges 421 of the blades 42. Therefore, it is possible to suppress an air stream that proceeds toward the upper surfaces of the blades 42, which are the negative pressure surfaces, over the lower surfaces of the blades 42, which are the positive pressure surfaces, at the front end portions in the rotation direction of the edges 421 of the blades 42 and to suppress reduction of an air stream flowing in the axial direction. Note that, the disclosure is not limited to this example and the maximum width portions 431 may be provided closer to the rear side in the rotation direction than the front end portions in the rotation direction of the edges 421 of the blades 42. In addition, 0.20*Lf<Lm<Lf may also be satisfied.

In addition, as described above, each assist blade 43 is provided with the variable width portion 432. At each variable width portion 432, the assist blade width WL decreases toward the rear side in the rotation direction from the front side in the rotation direction. Since the assist blade width WL increases toward a front end portion in the rotation direction at the variable width portions 432 of the assist blades 43, an air stream that proceeds to the upper surfaces, which are the negative pressure surfaces, from the lower surfaces of the blades 42, which are the positive pressure surfaces, is suppressed by the variable width portions 432. Furthermore, since the assist blade width WL decreases toward a rear end portion in the rotation direction, the generation of a turbulent stream on surfaces of the blades 42, particularly on the upper surfaces which are the negative pressure surfaces is suppressed and a load in the radial direction that is applied to the blades 42 due to a centrifugal force when an air stream is generated due to rotation of the impeller 4 is reduced. Therefore, it is possible to reduce a load that is applied to the blades 42 provided with the assist blades 43. Furthermore, since a load applied to the blades 42 is reduced, it is possible to secure a high static pressure and a large air volume in the axial fan 1.

More specifically, at the edges 421 of the blades 42, an air vortex is generated near negative pressure surfaces of the edges 421 due to an air stream that proceeds toward the negative pressure surfaces from the positive pressure surfaces. The air vortex that is generated at the front sides in the rotation direction of the blades 42 remains up to the vicinity of the rear end portions in the rotation direction of the blades 42 without being removed. Here, in a configuration in which the edges 421 are not provided with the assist blades 43, an air vortex that is generated at the front sides in the rotation direction of the edges 421 continuously develops toward the rear side in the rotation direction and thus the static pressure and air volume performance of the axial fan 1 are deteriorated. In addition, even in a configuration in which the assist blade width WL of the assist blades 43 is constant over an area from the front end portion in the rotation direction to the rear end portion in the rotation direction and in a configuration in which the assist blade width WL gradually increases toward the rear end portion in the rotation direction from the front end portion in the rotation direction, the static pressure and air volume performance of the axial fan 1 are deteriorated as with the configuration in which the edges 421 are not provided with the assist blades 43.

Meanwhile, when the assist blade width WL gradually decreases toward the rear side of the rotary portion as in the case of the variable width portions 432 in the present embodiment, the air vortex that is generated at the front sides in the rotation direction of the edges 421 remains up to the rear side in the rotation direction but is separate from the negative pressure surfaces of the blades 42. Therefore, there is only a little influence on the static pressure and air volume performance of the axial fan 1. That is, at the rear end portion in the rotation direction, a pressure difference between the positive pressure surfaces and the negative pressure surfaces is small and an air vortex is less likely to be generated in comparison with the front end portion in the rotation direction. An air vortex that is generated at the front end portion in the rotation direction is separate from the negative pressure surfaces of the blades 42 and does not excessively interfere with an air vortex that is generated at the rear end portion in the rotation direction. Therefore, there is only a little influence on the static pressure and air volume performance of the axial fan 1. Accordingly, with a configuration in which the assist blade width WL of the assist blades 43 gradually decreases toward the rear side of the rotary portion, it is possible to improve the static pressure and air volume performance of the axial fan 1.

At the variable width portions 432, the assist blade width WLa gradually decreases toward the rear side in the rotation direction from the front end in the rotation direction and in the present embodiment, the assist blade width WLa decreases toward the rear side in the rotation direction from the front sides in the rotation direction of the blades 42 in proportion to the rotation angle of the assist blades 43. Note that, the rotation angle is an angular width in the circumferential direction at the time of proceeding toward the rear side in the rotation direction from a predetermined position in the circumferential direction and here, the rotation angle is an angular width in the circumferential direction from the front end portions in the rotation direction of the variable width portions 432 and a position after movement to the rear side in the rotation direction. According to this configuration, it is possible to suppress a sudden change of an air stream in the vicinity of the assist blades 43 and to suppress a sudden change in load and stress in the radial direction that are applied to the blades 42 due to a centrifugal force at the time of generation of an air stream that occurs due to rotation of the impeller 4.

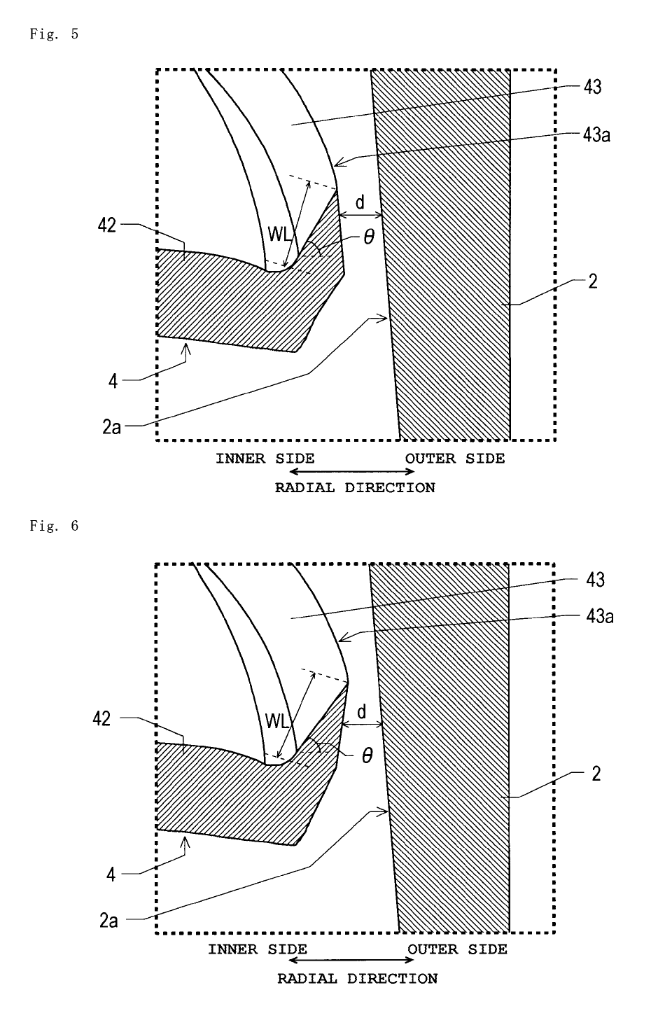

Preferably, at the maximum width portions 431, each of the radially inner surfaces of the assist blades 43 is parallel to the housing inner surface 2a or becomes closer to the housing inner surface 2a toward the axially upper side as illustrated in FIG. 5. FIG. 5 is an enlarged view illustrating an example of a sectional structure of the vicinity of the assist blade 43 at the maximum width portion 431. For example, the angle θ that is formed between the radially inner surface of the assist blade 43 at the maximum width portion 431 and a plane orthogonal to the central axis J1 is preferably equal to larger than 45 degrees and equal to smaller than 90 degrees. Since the above-described angle θ is equal to larger than 45 degrees and equal to smaller than 90 degrees, it is possible to suppress an air stream proceeding to the upper surfaces, which are the negative pressure surfaces, over the lower surfaces of the blades 42, which are the positive pressure surfaces, by means of the assist blades 43 that are appropriately inclined with respect to the radially inner surfaces of the assist blades 43, which are the negative pressure surfaces, at the maximum width portions 431.

Note that, the above-described angle θ corresponds to the inclination of the assist blades 43 and decreases toward the rear side in the rotation direction at the variable width portions 432. That is, the angle θ formed between each of the radially inner surfaces of the assist blades 43 and the plane orthogonal to the central axis J1 decreases toward the rear side in the rotation direction from the rear end portions in the rotation direction of the maximum width portions 431. Furthermore, the angle θ decreases toward the rear sides in the rotation direction of the blades 42 from the front sides in the rotation direction of the blades 42 in proportion to the rotation angle of the assist blades 43. According to this configuration, it is possible to suppress a sudden change of an air stream in the vicinity of the assist blades 43 and to suppress a sudden change in load and stress in the radial direction that are applied to the blades 42 due to a centrifugal force at the time of generation of an air stream that occurs due to rotation of the impeller 4.

In addition, the housing 2 faces the assist blades 43 in the radial direction. More specifically, the housing inner surface 2a faces the radially outer surfaces of the assist blades 43 in the radial direction with a gap provided therebetween. The radial width of the gap is constant as illustrated in FIG. 5. That is, a radial width d of a gap between the housing inner surface 2a and the radially outer surfaces of the assist blades 43 is uniform between the intake port 211 and the exhaust port 221. According to this configuration, since the radial width d of the above-described gap is constant, it is possible to suppress contact between the assist blades 43 and the housing 2. In addition, it is possible to suppress leakage of air that proceeds to the upper surfaces, which are the negative pressure surfaces, from the lower surfaces of the blades 42, which are the positive pressure surfaces, through the gap.

Note that, the disclosure is not limited to the example illustrated in FIG. 5 and a gap between the housing 2 and the assist blades 43 may not be constant. FIG. 6 is an enlarged view illustrating an example of another sectional structure in the vicinity of the assist blade 43 at the maximum width portion 431. For example, as illustrated in FIG. 6, the radial width d of the gap between the housing inner surface 2a and the radially outer surfaces of the assist blades 43 may increase toward the exhaust port 221 from the intake port 211. According to this configuration, since the radial width d of the above-described gap is changed as described above, the area by which air can flow through the gap between the housing inner surface 2a and the radially outer surfaces of the assist blades 43 increases toward the exhaust port 221, which is an air blowing port, from the intake port 211, which is an intake port. Therefore, it is possible to suppress the generation of a turbulent stream in the gap and thus it is possible to improve the static pressure in the axial fan 1 and to improve the air blowing efficiency of the axial fan 1.

Hereinabove, the embodiment of the disclosure has been described. Note that, the scope of the disclosure is not limited to the above-described embodiment. The disclosure can be implemented with various modifications without departing from the gist of the disclosure.

The disclosure is useful, for example, for an axial fan that is provided with an impeller including a blade with an assist blade provided on an edge.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An axial fan comprising:
an impeller that is provided with a blade that rotates around a central axis extending in a vertical direction;
a motor unit that rotates the impeller; and
a housing that is provided closer to a radially outer side than the impeller and surrounds the impeller;
wherein the impeller is further provided with an assist blade that protrudes at least in an axial direction from a radially outer end portion of the blade and extends in a circumferential direction, and
wherein the assist blade is provided with a variable width portion at which an assist blade width, between the blade and a tip end portion of the assist blade in a direction in which the assist blade protrudes, decreases toward a rear side in a rotation direction from a front side in the rotation direction.

2. The axial fan according to claim 1,
wherein the impeller is further provided with a tubular portion to which a radially inner end portion of the blade is connected,
wherein the assist blade is further provided with a maximum width portion at which the assist blade width becomes maximum,
wherein the maximum width portion is provided closer to the front side in the rotation direction than the variable width portion, and
wherein the assist blade width at the maximum width portion is equal to or greater than 5% of a radial width between the tip end portion of the assist blade and a radially outer end portion of the tubular portion and is equal to or smaller than 20% of the radial width.

3. The axial fan according to claim 2,
wherein the assist blade width at the variable width portion decreases toward the rear side in the rotation direction from the front side in the rotation direction of the blade in proportion to the rotation angle of the assist blade.

4. The axial fan according to claim 2,
wherein the maximum width portion is provided on a front end portion in the rotation direction of the radially outer end portion of the blade, and
wherein the length in the rotation direction of the maximum width portion is equal to or smaller than 20% of the length in the rotation direction of the radially outer end portion of the blade.

5. The axial fan according to claim 2,
wherein the angle that is formed between a radially inner surface of the assist blade at the maximum width portion and a plane orthogonal to the central axis is equal to or larger than 45 degrees and equal to or smaller than 90 degrees.

6. The axial fan according to claim 5,
wherein the angle that is formed between the radially inner surface of the assist blade and the plane orthogonal to the central axis decreases toward the rear side in the rotation direction from a rear end portion in the rotation direction of the maximum width portion.

7. The axial fan according to claim 6,
wherein the angle decreases toward the rear side in the rotation direction from the front side in the rotation direction of the blade in proportion to the rotation angle of the assist blade.

8. The axial fan according to claim 1,
wherein the length in the rotation direction of the assist blade is equal to or greater than 60% of the length in the rotation direction of the radially outer end portion of the blade and is equal to or smaller than 100% of the length in the rotation direction of the radially outer end portion.

9. The axial fan according to claim 8,
wherein a rear end portion in the rotation direction of the assist blade is positioned closer to the front side in the rotation direction than a rear end portion in the rotation direction of the radially outer end portion of the blade.

10. The axial fan according to claim 1,
wherein a radial width between the radially outer end portion of the blade and the central axis increases toward a rear end portion in the rotation direction of the blade from a front end portion in the rotation direction of the blade.

11. The axial fan according to claim 1,
wherein an air stream that flows from one side in the axial direction to the other side in the axial direction is generated when the impeller rotates,
wherein the housing is provided with
a housing inner surface that faces a radially outer surface of the assist blade in a radial direction with a gap provided therebetween,
a first opening portion that is provided closer to the one side in the axial direction than the impeller, and
a second opening portion that is provided closer to the other side in the axial direction than the impeller, and
wherein a radial width of the gap between the housing inner surface and the radially outer surface of the assist blade is uniform between the first opening portion and the second opening portion.

12. The axial fan according to claim 1,
wherein an air stream that flows from one side in the axial direction to the other side in the axial direction is generated when the impeller rotates,
wherein the housing is provided with
a housing inner surface that faces a radially outer surface of the assist blade in a radial direction with a gap provided therebetween,
a first opening portion that is provided closer to the one side in the axial direction than the impeller, and
a second opening portion that is provided closer to the other side in the axial direction than the impeller, and
wherein a radial width of the gap between the housing inner surface and the radially outer surface of the assist blade increases toward the second opening portion from the first opening portion.

13. The axial fan according to claim 11,
wherein, as seen in the axial direction, the minimum radial width between the housing inner surface and the central axis is smaller than the maximum radial width between the radially outer end portion of the blade and the central axis.

14. The axial fan according to claim 13,
wherein a rear end portion in the rotation direction of the radially outer end portion of the blade is positioned closer to the radially outer side than the first opening portion.

15. The axial fan according to claim 11,
wherein, as seen in the axial direction, the minimum radial width between the housing inner surface and the central axis is larger than the maximum radial width between the radially outer end portion of the blade and the central axis.
